(19) United States
(12) Patent Application Publication
(10) Pub. No.: US 2015/0097088 A1
(43) Pub. Date: Apr. 9, 2015

(54) Mobile Electronic Device Cord Holder

(71) Applicant: Joel McMahon, Atlanta, GA (US)

(72) Inventor: Joel McMahon, Atlanta, GA (US)

(21) Appl. No.: 14/292,878

(22) Filed: May 31, 2014

Related U.S. Application Data
(60) Provisional application No. 61/879,426, filed on Oct. 4, 2013.

(51) Int. Cl. F16L 3/123; F16M 11/22; F16L 3/12

(52) U.S. Cl. CPC F16L 3/1236; F16L 3/1218; F16L 3/1226; F16M 11/22
USPC 248/49

(57) ABSTRACT

A mobile electronic device cord holder for securing device cords is provided. The cord holder includes a body with a channel extending lengthwise between the ends of the body, an access slot open to the top of the body and having a width whereby at least one electronic device cord is insertable and removable from the channel, a non-skid covering affixed to the channel to provide resistance to motion of the device cords through the channel, and a non-skid surface affixed to the base, whereby with electronic device cords positioned within the channel, the weight of the cord holder and the surface resistance of the base together provide resistance to motion so that the position of the cord holder and the electronic device cords is retained.

### CROSS-REFERENCE TO RELATED APPLICATIONS

This application claims the benefit of U.S. Provisional Application No. 61/879,426, entitled “Mobile Electronic Device Cord Holder,” filed Oct. 4, 2013, which is incorporated herein by reference as if set forth herein in its entirety.

### BACKGROUND

The present state of technology includes an array of devices having individual power cords, charging cords, connector cords, and other such like, that are continuously being plugged and unplugged to the device. With this onslaught of devices, comes the disorganization of having multiple cords in various states of disarray on a desk, for example. Workstations and entertainment centers have a similar upsurge in the number of cords requiring availability for various devices. Added to the seemingly ever-increasing number of device cords is the likelihood that many cords fall beside or behind the desk, workstation, or entertainment center when disconnected from the device.

Desks, workstations, entertainment centers, and other locales for the many electronic devices can be difficult, and sometimes even hazardous, to move in the attempt to retrieve a particular cord gone astray. Fishing behind a desk for a fallen cord can be time-consuming so that the lost man-hours pile up unnecessarily. The problems are compounded for the elderly or disabled so that the fallen cords essentially become irretrievable without assistance.

Many existing devices for securing electronic device cords such as chargers, sync cables, and related interface cords require attachment to a workstation surface or are otherwise cumbersome and difficult to utilize effectively. Such attachment leads to damage of the surface area in and around the various electronic and other type devices. Attachment to a surface area also contributes to decreased mobility of the devices. Matters are further complicated with the need for moving the device, associated power cords, connectors, and assorted materials, to a different workstation.

### BRIEF SUMMARY

This invention pertains to securing cords in place. More particularly, this invention pertains to securing mobile electronic device cords and other type device cords in place at desks, workstations, entertainment centers, and such like. Existing cord holder devices often damage the surface in and around various electronic and other type devices. The disclosed cord holder provides for securing electronic device cords, connector cords, and the like in place on surface areas while also reducing or eliminating the movement of the cord holder.

Briefly described, and according to one embodiment, a cord holder for securing electronic device cords is provided. The cord holder includes (a) a substantially rectangular body having a top, a base, first and second ends, and front and rear faces, (b) a channel extending lengthwise from the first end to the second end of the body, (c) an access slot extending from the first end to the second end of the body, open to the top of the body, and having a width whereby at least one electronic device cord is insertable and removable from the channel, (d) a cover affixed to at least a portion of the channel to provide resistance to lengthwise motion of the electronic device cords through the channel, and (e) the base comprising a surface resistance to motion from forces that arise from the electronic device cords, whereby with electronic device cords positioned within the channel, the weight of the cord holder and the surface resistance of the base together provide resistance to motion so that cord holder position and electronic device cord position are retained.

In one embodiment, the channel is substantially circular along the length of the body, while the channel has a diameter exceeding the width of the access slot. According to one embodiment, the diameter exceeds the width of the access slot by fifty percent. In another embodiment, the channel has a tear-drop shape along the length of the body.

In one embodiment, the cover affixed to the channel is a rubberized non-skid material. In another embodiment, the cover affixed to the channel is non-skid compressible foam.

In one embodiment, a non-skid material is affixed to the bottom of the body to provide the surface resistance of the base. In another embodiment, the non-skid material is a non-skid foam material. In yet another embodiment, the non-skid material is a rubberized non-skid coating material.

According to another embodiment, a cord holder for securing device cords is provided. The cord holder includes (a) a body having a base, (b) a channel extending from a first side to a second side of the body, (c) an access slot extending from the first side to the second side of the body, providing an opening having a width whereby electronic device cords are insertable and removable from the channel, (d) a cover affixed to at least a portion of the channel to provide resistance to lengthwise motion of electronic device cords through the channel, and (e) the base comprising a surface resistance to motion from forces that arise from electronic device cords, so that with electronic device cords positioned within the channel, the cord holder retains cord holder position and electronic device cord position

Other systems, methods, features and advantages of the present invention will be or become apparent to one with skill in the art upon examination of the following drawings and detailed description. It is intended that all such additional systems, methods, features and advantages be included within this description and be within the scope of the present disclosure.

### BRIEF DESCRIPTION OF THE DRAWINGS

The above-mentioned features will become more clearly understood from the following detailed description read together with the drawings in which:

FIG. 1 is a perspective view of a mobile electronic device cord holder;

FIG. 2-A is an end view of the mobile electronic device cord holder of FIG. 1;

FIG. 2-B is an end view of an alternate embodiment of the mobile electronic device cord holder;

FIG. 2-C is an end view of another alternate embodiment of the mobile electronic device cord holder;

FIG. 2-D is an end view of yet another alternate embodiment of the mobile electronic device cord holder;

FIG. 3 is a top view of the mobile electronic device cord holder;

FIG. 4 is a bottom view of the mobile electronic device cord holder;

FIG. 5 is a cut-away view showing the access slot and the channel of the mobile electronic device cord holder;

FIG. 6 is an exemplary embodiment of a mobile electronic device cord holder securing an electronic device cord;

FIG. 7 is an exemplary embodiment of a mobile electronic device cord holder securing a plurality of electronic device cords; and

FIG. 8-A illustrates an alternative embodiment of a mobile electronic device cord holder;

FIG. 8-B illustrates another alternative embodiment of a mobile electronic device cord holder; and

FIG. 8-C illustrates yet another alternative embodiment of a mobile electronic device cord holder.

### DETAILED DESCRIPTION

A cord holder apparatus for securing device cords in place on desks, workstations, entertainment centers, and such like, is disclosed. The cord holder provides for securing electronic device cords, connector cords, and other types of device cords in place without damaging the surface area in and around various electronic devices and other type devices.

The present state of technology includes an array of devices having individual power cords, charging cords, connector cords, and other such like, that are continuously being plugged and unplugged to the device. With this onslaught of devices, comes the disorganization of having multiple cords in various states of disarray on a desk, for example. Workstations and entertainment centers have a similar upsurge in the number of cords requiring availability for various devices. Added to the seemingly ever-increasing number of device cords is the likelihood that many cords fall beside or behind the desk, workstation, or entertainment center when disconnected from the device.

Desks, workstations, entertainment centers, and other locales for the many electronic devices can be difficult, and sometimes even hazardous, to move in the attempt to retrieve a particular cord gone astray. Fishing behind a desk for a fallen cord can be time-consuming so that the lost man-hours pile up unnecessarily. The problems are compounded for the elderly or disabled so that the fallen cords essentially become irretrievable without assistance.

Many existing devices for securing electronic device cords such as chargers, sync cables, and related interface cords require attachment to a workstation surface or are otherwise cumbersome and difficult to utilize effectively. Such attachment leads to damage of the surface area in and around the various electronic and other type devices. Attachment to a surface area also contributes to decreased mobility of the devices. Matters are further complicated with the need for moving the device, associated power cords, connectors, and assorted materials, to a different workstation.

The mobile electronic device cord holder disclosed herein provides a sturdy device that provides for securing the cords so that they do not fall or otherwise clutter the work area. Multiple cords may be secured with a single cord holder. The mobile electronic device cord holder also prevents other inconveniences attributed to electronic device cord management while causing no damage to the desk or workstation surfaces.

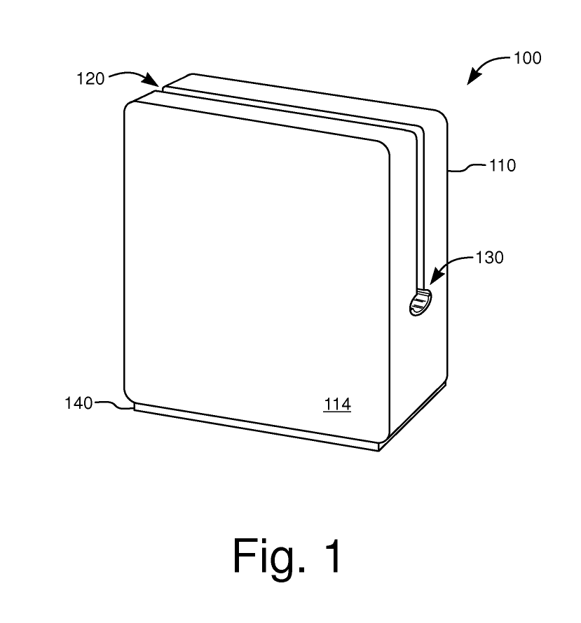

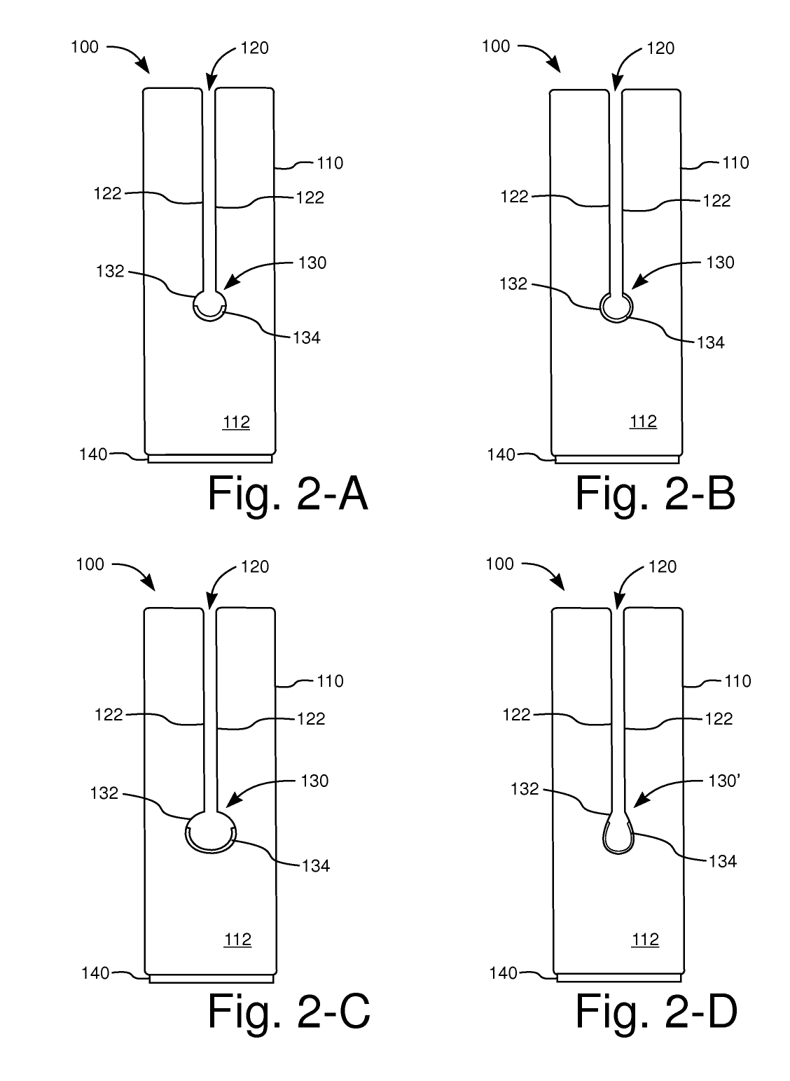

FIG. 1 is a perspective view of a mobile electronic device cord holder 100. FIG. 2-A is an end view of the cord holder 100, FIG. 2-B is an end view of an alternate embodiment of the cord holder 100, FIG. 2-C is an end view of another alternate embodiment of the cord holder 100, and FIG. 2-D is an end view of yet another alternate embodiment of the cord holder 100. It should be noted that the cord holder 100 is suitable for many type cords such as those for attachment to mobile electronic devices and other electronic devices including laptops, tablets, mobile phones, music devices, and many other such like devices.

In the illustrated embodiment, the cord holder 100 includes a substantially rectangular, block-shaped body 110, an access slot 120 for inserting and removing device cords, a channel 130 for placement of the device cords, and a non-skid base 140. Additionally, the body 110 also includes opposing ends 112 (first end, second end) substantially identical to each other, and opposing faces 114 (front face, rear face) that are substantially identical to each other. Together, the weight of the body 110 and the surface resistance of the base 140 (discussed further below) provide resistance against unwanted slippage or motion of the cord holder 100 due to gravity, leveraging, and/or orientation of any cords that extend through the channel 130.

In various embodiments, the body 110 is formed of stone, marble, glass, metal, or composites, among other such materials. The body 110 may be formed by cutting or carving a desired material, or even formed via injection molding via placing a material into a mold. The body 110 provides sufficient density and weight to protect against unintentional or unwanted motion of the cords. The structure of the body 110 provides for a variety of styles, textures, and/or other aesthetic considerations in the design of the cord holder 100. It will be appreciated by those skilled in the art, that the body 110 may be formed from any natural or man-made material providing sufficient heft to provide resistance against unwanted or unintentional motion of the cord holder 100 due to the orientation and/or gravitational forces acting upon the secured cords. In some embodiments, the body 110 of the cord holder 100 is formed from a non-skid material. In such embodiments, a non-skid material can be any material that provides friction resistance to slippage or motion of the body 110 on surfaces where the cord holder 100 is used, while also providing resistance to slippage or motion of any cords within the channel 130 of the body 110.

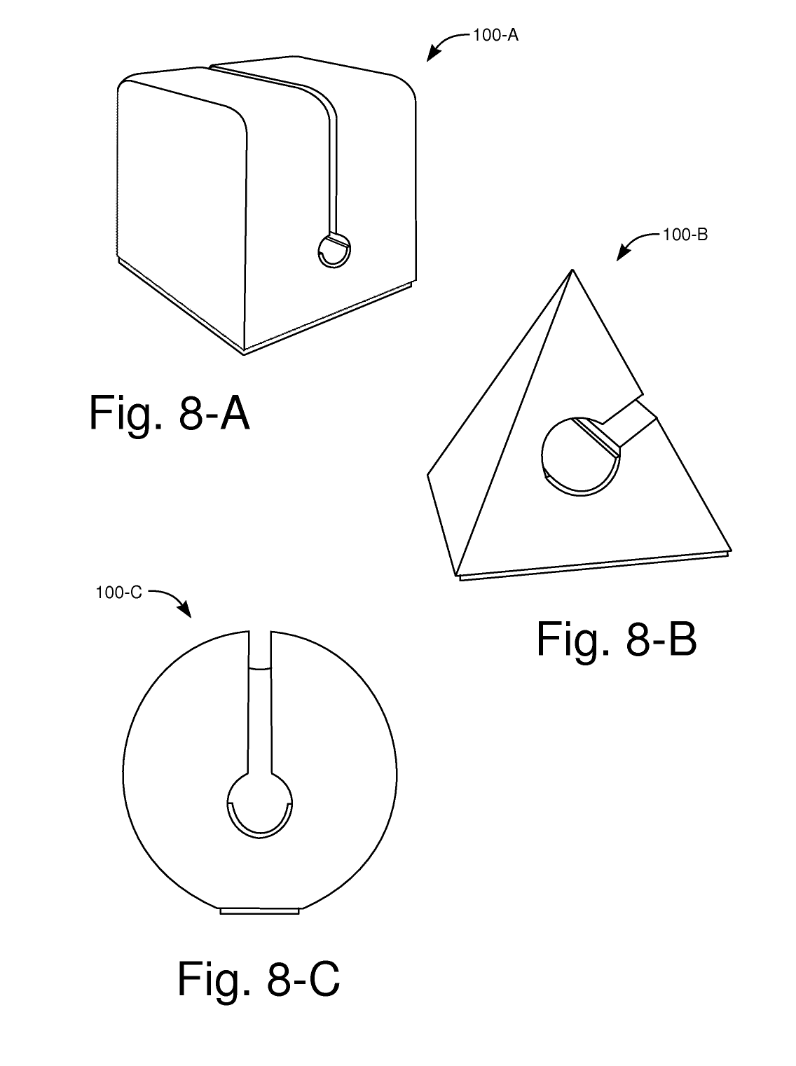

In various alternative embodiments (see FIG. 8-A, FIG. 8-B, FIG. 8-C below), the body of the cord holder 100 is shaped as a substantially rectangular block (height less than that of FIG. 1), a three or four-sided pyramid, or a spherical object. The structure of each such alternative cord holder 100-A, 100-B, 100-C is substantially similar in having a body that includes a non-skid base, a channel, and an access slot opening generally upward from the base. It is intended that this disclosure encompasses such variations in the body of the varying cord holders 100.

The access slot 120 opens to the top the body 110 and opposite the base 140 so that the preferred orientation is with the cord holder 100 resting on its base 140 in an upright position to expose the slot 120. In such a configuration, the access slot 120 provides an opening upward and opposite the base 140. The access slot 120 is positioned along the length of the cord holder 100 from the first end to the second end and mid-way between the front and rear faces 114 of the cord holder 100. The access slot 120 has a width bounded by identical walls 122 and accommodates a wide variety of electronic device cords such as those used for smart phones, tablets, laptops, music devices, and many other such devices.

A channel 130 runs along the length of the body 110 at the lower end of the slot 120. That is the channel 130 intersects the slot 120 at the bottom of the slot 120 toward the base 140. In the illustrated embodiment, the channel 130 as viewed from either end of the body 110 is substantially circular in shape and having a diameter that exceeds the width of the slot 120. In one such embodiment, the channel 130 has a substantially circular shape with a diameter that is at least half-again larger than the width of the slot 120. In such an embodiment, the channel 130 accommodates device cords having a total cross-section approximately three times that of a device cord having a width that is approximately that of the slot 120. In other embodiments, the channel 130 has a shape approximating a tear-drop (see FIG. 2-D), a semi-circle (not shown), or other shapes. It should be appreciated that in various embodiments, the shape of the channel 130 as viewed from the end of the body 110 may be any desirable shape and/or size dimensions that provide sufficient cross-sectional area for the expected device cords to be positioned within the channel 130. It should be appreciated that the cross-section area of the channel 130 may be larger or smaller than the illustrated embodiment according to the anticipated use and number of device cords to be positioned within the channel 130.

In one embodiment, the diameter of the channel 130 is less than the width of the heads or connectors of the device cords. This provides an additional mechanism for preventing the device cords from sliding through the channel 130, thus preserving the location and accessibility of the device cords for use with the appropriate device.

The channel 130 includes a cover 134 affixed to at least a portion of the wall 132 along the length of the channel 130. The cover 134 provides resistance to motion of cords that extend through the channel 130. That is, the cover 134 provides sufficient texture and/or other resistant forces to prevent unwanted motion of the cords and therefore secure the cords within the channel 130. In one embodiment, the cover 134 is a rubberized non-skid material. In one such embodiment, the cover 134 is an acrylic, rubberized non-skid cover applied to the wall 132 of the channel 130. In another embodiment, the cover 134 is non-skid foam affixed to the wall 132 via an adhesive. In another embodiment, the cover 134 is a foam or rubberized material that compresses due to the insertion of cords into the channel 130 and provides a flexible or spring-like resistance to motion of the cords. It will be appreciated by those skilled in the art, that the cover 134 can be any material that provides friction resistance to slippage or motion of typical electronic device cords that extend through the channel 130.

In the illustrated embodiment of FIG. 2-A, the cover 134 provides a coating on the lower half of the channel 130 along its length from one end 112 of the body 110 to the other. In another embodiment, illustrated in FIG. 2-B, the cover 134 coats the entirety of the wall 132 of the channel 130 along its length between the ends 112 of the body 110. In yet another embodiment, illustrated in FIG. 2-C, the cover 134 coats a portion of the wall 132 of a channel 130 having a wide circle shape that approaches an oval. In yet another embodiment, illustrated in FIG. 2-D, the cover 134 coats a significant portion of the wall 132 of a channel 130 having a teardrop shape. In various embodiments, the cover 134 may be affixed as a coating to any portion of the wall 132 sufficient to provide resistance to slippage or motion of the cords extending through the channel 130. As noted above, the shape of the channel 130 as viewed from the end of the body 110 may be any desirable shape and/or size dimensions that provide sufficient cross-sectional area for the expected device cords to be positioned within the channel 130 and also provides for a cover 134 on the wall 132.

The base 140 of the body is a material that provides stability in the positioning of the cord holder 100. In one embodiment, the base 140 is a non-skid foam material affixed to the bottom or underside of the body 110. In one such embodiment, the base 140 is affixed to the body 110 via a permanent rubber adhesive. The adhesive is affixed to one side of the non-skid foam which is then applied to the bottom of the body 110 to form a base 140. In another embodiment, the base 140 is an acrylic, rubberized non-skid coating applied to bottom of the body 110. It will be appreciated by those of skill in the art that other non-skid materials may be affixed to the bottom of the body 110 to form a non-skid base 140 that is resistant to slippage or motion due to the device cords that extend through the channel 130.

One benefit of the non-skid base 140 is protection of surface areas on which the cord holder is placed. A historical problem with devices to secure cords in place is the necessity to permanently attach such cord holders to the surface area via various type fasteners or permanent adhesives. These necessarily scuff, scrape, or otherwise mar the surface area permanently which is undesirable, particularly for desks or entertainment centers.

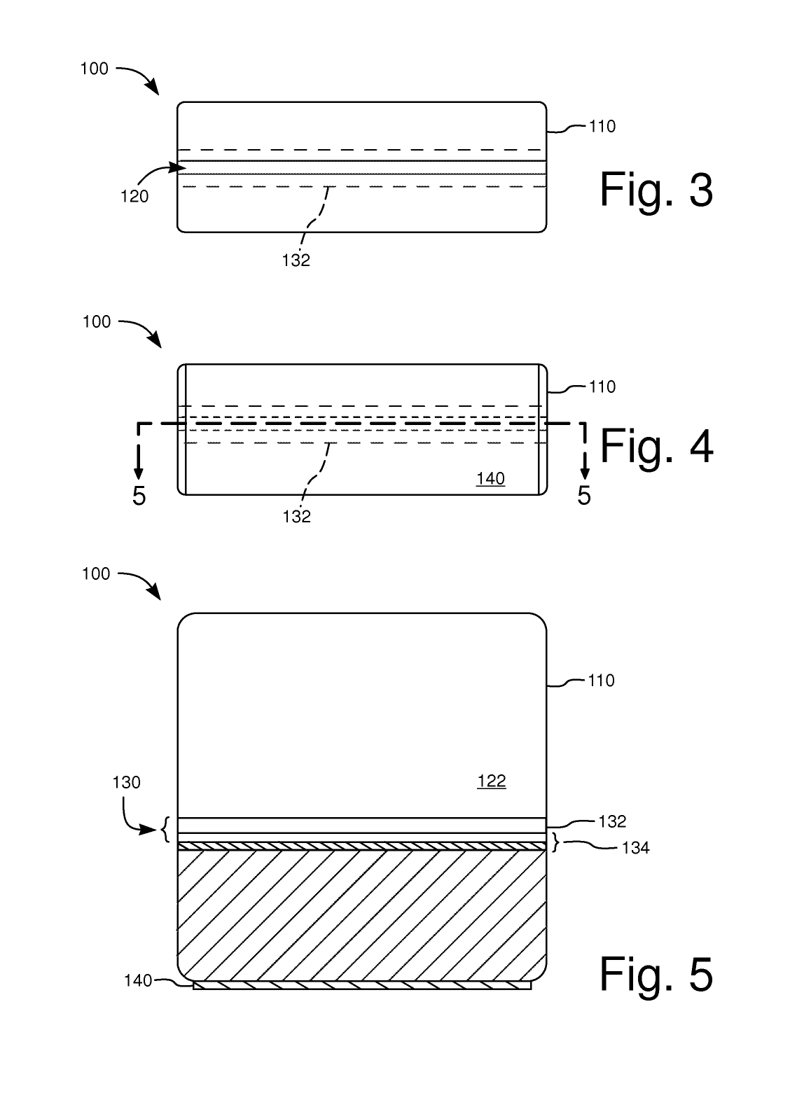

FIG. 3 is a top view of the cord holder 100. The access slot 120 opens to the top of the body 110 and extends along the length of the cord holder 100 from the first end to the second end. The access slot 120 is situated substantially mid-way between the front and rear faces 114 of the cord holder 100. The width of the access slot 120 accommodates a wide variety of electronic device cords such as those used for smart phones, tablets, laptops, music devices, and many other such devices.

The channel 130 has a diameter that exceeds the width of the access slot 120. In this way, multiple device cords are inserted through the access slot 120 and into the channel 130. The number of cords placed into the channel 130 improves retention of the cords as well as limiting their slippage or motion through the channel 130.

Device cords are inserted through the access slot 120 for positioning within the channel 130. Of course, device cords are also removed from the channel 130 via the access slot 120. While the channel 130 is typically not visible from the top of the cord holder 100, the outer boundary of the wall 132 for one embodiment of the cord holder 100 is illustrated via dashed lines in FIG. 3.

FIG. 4 is a bottom view of the cord holder 100. A non-skid base 140 substantially covers the bottom of the body 110. The access slot 120 and the channel 130 are not visible from the bottom of the cord holder 100. The access slot 120 and the wall 132 of the channel are illustrated via separate dashed lines in FIG. 4.

As noted above, the non-skid base 140 provides a sufficient coefficient of friction to prevent slippage or motion of the cord holder away from its position due to gravity and/or positioning of the device cords. The stability provided by the non-skid base 140 improves organization and provides the capability for securing many device cords in place without sacrificing the convenience of a stand-alone device while also not risking damage to the desk or other work area.

FIG. 5 is a cut-away view illustrating the access slot 120 and channel 130 of the cord holder 100. One access slot wall 122 of the access slot 120 is visible along with a portion of the channel 130 in the cut-away view. The visible portion of the channel 130 includes a portion of the channel wall 132 and a portion of the wall cover 134.

As noted above, the weight of the body 110 and the surface resistance of the base 140 together provide resistance against unwanted slippage or motion of the cord holder 100 due to gravity and/or orientation of any cords that extend through the channel 130. The structure of the body 110 provides for a variety of styles, textures, and/or other aesthetic considerations in the design of the cord holder 100.

It will be appreciated by those skilled in the art, that the body 110 may be formed from any natural or man-made material providing sufficient heft to provide resistance against unwanted or unintentional motion of the cord holder 100 due to the orientation and/or gravitational forces acting upon the secured cords.

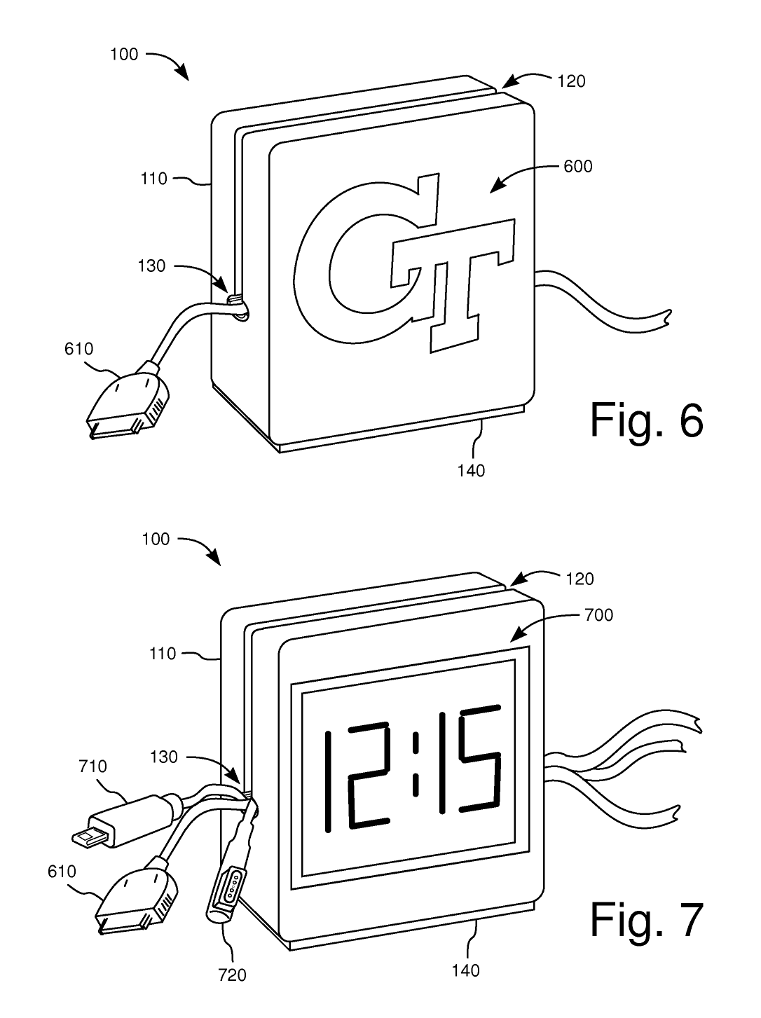

FIG. 6 is an exemplary embodiment of a mobile electronic device cord holder 100 securing an electronic device cord 610, and FIG. 7 is an exemplary embodiment of a mobile electronic device cord holder 100 securing a plurality of electronic device cords 610, 710, 720. The cord holder 100 provides sufficient stability and resistance via both the channel 130 and the non-skid base 140 to secure even a single electronic device cord in place. As is evident in FIG. 7, the addition of multiple device cords provides even greater stability since the plurality of cords increase the resistance within the channel 130 of the cord holder 100.

Additionally, the blank faces 114 are modified to provide for decoration and or embellishment in various forms. Such modifications may include a logo 600 for a college or professional sports team, or a digital clock 700, for example. The face 114 provides for placement of photographs, emblems, artwork, or even programmable electronic paper. The cord holder 100 provides for endless specialized personalization capability of one or both faces 114.

In one embodiment, a face 114 of the cord holder 100 is provided with programmable electronic paper for display of various images. An electronic paper or e-paper display is a display technology that mimics the appearance of ink and paper. E-paper displays reflect light like ordinary paper, provides for more comfortable viewing or reading, and provides a wider viewing angle as compared to conventional display technologies. An ideal e-paper display can be read in direct sunlight without the image appearing to fade. In the illustrated embodiments of FIG. 6, an e-paper display provides a programmable or changeable image, and uses no power except when being reprogrammed. An e-paper display could even provide for the digital clock of FIG. 7 with an additional battery power source.

FIG. 8-A illustrates an alternative embodiment of a mobile electronic device cord holder 100-A. FIG. 8-B illustrates another alternative embodiment of a mobile electronic device cord holder 100-B. FIG. 8-C illustrates yet another alternative embodiment of a mobile electronic device cord holder 100-C. It should be apparent from the varying configurations of the mobile electronic device cord holders 100, 100-A, 100-B, 100-C that a multitude of shapes may be provided while maintaining the core functionality described above. It is intended that these and other such variations are encompassed within the scope of the present disclosure.

From the foregoing description, it will be recognized by those skilled in the art that a mobile electronic device cord holder 100, that includes a substantially rectangular, block-shaped body 110, an access slot 120 for inserting and removing device cords, a channel 130 for insertion and removal of the device cords, and a non-skid base 140, has been provided.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

What is claimed is:

1. A cord holder for securing electronic device cords, the device cord holder comprising:
a substantially rectangular body having a top, a base, first and second ends, and front and rear faces, the body having a length, a width, and a height, wherein the height is greater than the width;
a channel extending lengthwise from the first end to the second end of the body, wherein the channel is substantially circular along the length of the body;
an access slot extending from the first end to the second end of the body, the access slot open to the top of the body, the access slot having a width between two edges whereby at least one electronic device cord is insertable and removable from the channel via the access slot;
a non-skid cover affixed to at least a portion of the channel to provide resistance to lengthwise motion of the at least one electronic device cord through the channel; and
the base comprising a non-skid material affixed to the bottom of the body to provide surface resistance to motion from forces that arise from the at least one electronic device cord,
whereby with at least one electronic device cord positioned within the channel, the weight of the cord holder and the surface resistance of the base together provide resistance to motion so that cord holder position and electronic device cord position are retained.

2. The cord holder of claim 1, wherein the diameter exceeds the width of the access slot by fifty percent.

3. The cord holder of claim 1, wherein the cover is a rubberized material.

4. The cord holder of claim 1, wherein the cover affixed to at least a portion of the channel is compressible foam.

5. The cord holder of claim 1, wherein the non-skid material affixed to the based is a foam material.

6. The cord holder of claim 1, wherein the non-skid material affixed to the based is a rubberized coating material.

7. The cord holder of claim 1, wherein the body is made from at least one of stone, marble, glass, a composite material, a non-skid material.

8. A cord holder for securing electronic device cords, the device cord holder comprising:
a substantially rectangular body having a top, a base, first and second ends, and front and rear faces;
a channel extending lengthwise from the first end to the second end of the body;
an access slot extending from the first end to the second end of the body, the access slot open to the top of the body, the access slot having a width whereby at least one electronic device cord is insertable and removable from the channel via the access slot;
a cover affixed to at least a portion of the channel to provide resistance to lengthwise motion of the at least one electronic device cord through the channel; and
the base comprising a surface resistance to motion from forces that arise from the at least one electronic device cord,
whereby with at least one electronic device cord positioned within the channel, the weight of the cord holder and the surface resistance of the base together provide resistance to motion so that cord holder position and electronic device cord position are retained.

9. The cord holder of claim 8, wherein the channel is substantially circular along the length of the body, the channel having a diameter exceeding the width of the access slot.

10. The cord holder of claim 8, wherein the diameter exceeds the width of the access slot by fifty percent.

11. The cord holder of claim 8, wherein the channel has a substantially semi-circular shape along the length of the body.

12. The cord holder of claim 8, wherein the cover is a rubberized non-skid material.

13. The cord holder of claim 8, wherein the cover affixed to at least a portion of the channel is non-skid compressible foam.

14. The cord holder of claim 8, further comprising a non-skid material affixed to the bottom of the body to provide the surface resistance of the base.

15. The cord holder of claim 14, wherein the non-skid material is a non-skid foam material.

16. The cord holder of claim 14, wherein the non-skid material is a rubberized non-skid coating material.

17. A cord holder for securing electronic device cords, the device cord holder comprising:
a body having a base;
a channel extending from a first side to a second side of the body;
an access slot extending from the first side to the second side of the body, the access slot providing an opening and having a width whereby at least one electronic device cord is insertable and removable from the channel via the access slot;
a cover affixed to at least a portion of the channel to provide resistance to lengthwise motion of the at least one electronic device cord through the channel; and
the base comprising a surface resistance to motion from forces that arise from the at least one electronic device cord,
so that with at least one electronic device cord positioned within the channel, the cord holder retains cord holder position and electronic device cord position.

18. The cord holder of claim 17, wherein the body is made from at least one of stone, marble, glass, a composite material, a non-skid material.
